(19) United States
(12) Patent Application Publication
(10) Pub. No.: US 2024/0174439 A1
(43) Pub. Date: May 30, 2024

(54) DEVICE FOR LOADING AND UNLOADING PALLETS IN A DELIVERY STATION

(71) Applicant: 1MROBOTICS LTD., Bnei Darom (IL)

(72) Inventors: DAVID PRAIV, MODIIN (IL); OFEK AYLON, TEL AVIV (IL); AMIT STEINBERG, TEL AVIV (IL); YUVAL BARASHI, MODIIN (IL); EYAL YAIR, BNEI DAROM (IL); ROEE TUVAL, HOLON (IL)

(21) Appl. No.: 17/994,335

(22) Filed: Nov. 27, 2022

(51) Int. Cl. B65G 1/04; B66F 9/07; B66F 9/075

(52) U.S. Cl. CPC B65G 1/0435; B66F 9/072; B66F 9/0755; B65G 2203/0283

(57) ABSTRACT

A delivery station for delivering goods, including a main track, one or more storage devices located along the main track, where the storage devices store the goods delivered by the delivery station, a push-pull device configured to move along the main track, where the push-pull device is configured to carry one of the storage devices along the main track, the push pull device including an actuator for moving the push-pull device, and a mechanism configured to lock on one of the storage devices and to move the one of the one or more storage devices in a direction perpendicular to a longitudinal axis of the main track.

### FIELD

The invention relates generally to autonomously loading and unloading goods in a delivery station.

### BACKGROUND

There is a growing need for delivery services, mainly in the on-demand space. Consumers require that the goods are provided within short time durations (SLAs), sometimes within an hour or two, or even less, from the request time. This requires companies to increase efforts in the “last mile”, to be closer to the consumers' residences and offices, as opposed to having larger warehouses outside city centers, which was the standard in the past. Companies need sufficient geographic coverage in cities in order to supply the goods quickly.

The goods are manufactured in the factory, then transferred to a regional warehouse, and from the regional warehouse they are transported to the “last mile” facilities (close to the consumers). The facilities may be shops that also work with delivery services which provide the goods to the consumers, or enable the consumers to come to the shops and collect the goods.

Fulfillment of last mile logistics in less than two hours is expensive, difficult and error-prone. For example, it involves challenging human resources management of low-skilled staff for recruiting, retaining, operating at multiple shifts, all potentially unreliable and inaccurate operations that lead to about 3% errors in orders due to manual packaging, stock visibility issues, restock forecasting, etc. Another challenge is inconsistent order preparation time that may take anywhere from 4 to 10 minutes.

Some of the above challenges may be solved by automating the delivery process. Additional challenges are high real estate costs, especially in metropolitan areas and the difficulty to setup Point of Consumer (POCs), a third party to act as a reseller or dark stores, which are needed to be in proximity to consumers. Another challenge is to align inventory with demand fluctuations; support for a single SKU is different from multi-SKUs.

### SUMMARY

The invention, in embodiments thereof, discloses a delivery station for delivering goods, comprising a main track; one or more storage devices located along the main track, the one or more storage devices store the goods delivered by the delivery station; a push-pull device configured to move along the main track, said push-pull device is configured to carry one of the one or more storage devices along the main track, said push pull device comprises an actuator for moving the push-pull device and a mechanism configured to lock on one of the one or more storage devices and to move the one of the one or more storage devices in a direction perpendicular to a longitudinal axis of the main track.

In some cases, the mechanism comprises a chain movable around the push-pull device, wherein movement of the chain moves the one of the one or more storage devices towards the main track or away from the main track. In some cases, the chain comprises multiple interconnected chain members, at least one of the interconnected chain members is a locking unit configured to be locked inside niches on a bottom part of one of the one or more storage devices.

In some cases, the push-pull device further comprises a lateral driver coupled to the chain, wherein the lateral driver moves the chain in a direction perpendicular to a longitudinal axis of the main track. In some cases, the lateral driver comprises a driver connector, said driver connector is coupled on a distal part to a linear guide of the chain and on a proximal part to a moving axis, wherein movement of the moving axis results in linear movement of the chain in a direction perpendicular to a longitudinal axis of the main track. In some cases, the push-pull device further comprises a chain actuator configured to move the chain.

In some cases, the delivery station further comprises a track bus configured for carrying the push-pull device, wherein the track bus comprises an interface configured to move along the main track. In some cases, the track bus further comprises a forward pusher configured to move the push-pull device along a longitudinal axis of the main track. In some cases, the track bus further comprises a movable connector configured to supply electrical power to the one of the one or more storage devices when carried by the push-pull device, wherein the movable connector moves upwards when the one of the one or more storage devices is located in a predefined location on top of the push-pull device. In some cases, the track bus further comprises a sensor for sensing the predefined location of the one of the one or more storage devices on top of the push-pull device.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows an external view of the delivery station, according to exemplary embodiments of the invention.

FIG. 2 shows a storage volume of the delivery station, according to exemplary embodiments of the invention.

FIG. 3 shows a track bus for carrying the push-pull device, according to exemplary embodiments of the invention.

FIGS. 4A-4C show a track bus in a partially exploded view, according to exemplary embodiments of the invention.

FIGS. 5A-5B show a push-pull device, assembled and in a partially exploded view, according to exemplary embodiments of the invention.

FIGS. 6A-6G show the push-pull device in various positions when loading and unloading a pallet, according to exemplary embodiments of the invention.

FIGS. 7A-7B show a movable connector of the push-pull device, according to exemplary embodiments of the invention.

FIG. 8 shows a method for moving a pallet from a volume, according to exemplary embodiments of the invention.

### DETAILED DESCRIPTION

The technical challenge solved using the invention is to provide automated stations that can supply goods quickly and accurately, without consuming big areas, as the real estate in cities is very expensive. Further, the technical challenge is to load and unload pallets that carry the goods inside delivery stations. The delivery stations may be designed with main tracks and platforms on both sides of the track, the platforms are configured to carry the pallets when loaded from outside the delivery station, for example when transported on a truck or train.

The technical solution disclosed by embodiments of the invention is a fully autonomous delivery station configured to dispense goods, for example to an end-user or to a delivery person. The delivery station comprises physical components for receiving the goods, loading the goods in specific locations in the system, receiving orders and providing the orders. The term fully autonomous is defined in a manner that the station does not need any person to operate the components disclosed herein.

The term “goods” refers to items that satisfy human wants and provide utility, for example, to a consumer making a purchase of a satisfying product. The goods in the delivery station may be packed, for example in cans, bottles, plastic boxes, cardboard boxes, bags made of polymers such as polyethylene and the like. The goods may be food products, beverages, electronic appliances, games, toys, clothes and the like.

The term “storage devices” refers to an object in the housing that stores goods. The object may be a shelf, a container, a box, a pallet and the like. The storage device may be flat transport structure, which supports goods in a stable fashion while being lifted by another object, such as forklift, a pallet jack, a front loader, a jacking device, or an erect crane. The storage devices may be secured to the body of the housing with strapping, stretch wrap or shrink wrap. The storage devices can also be made of plastic, metal, wood, paper, and other materials.

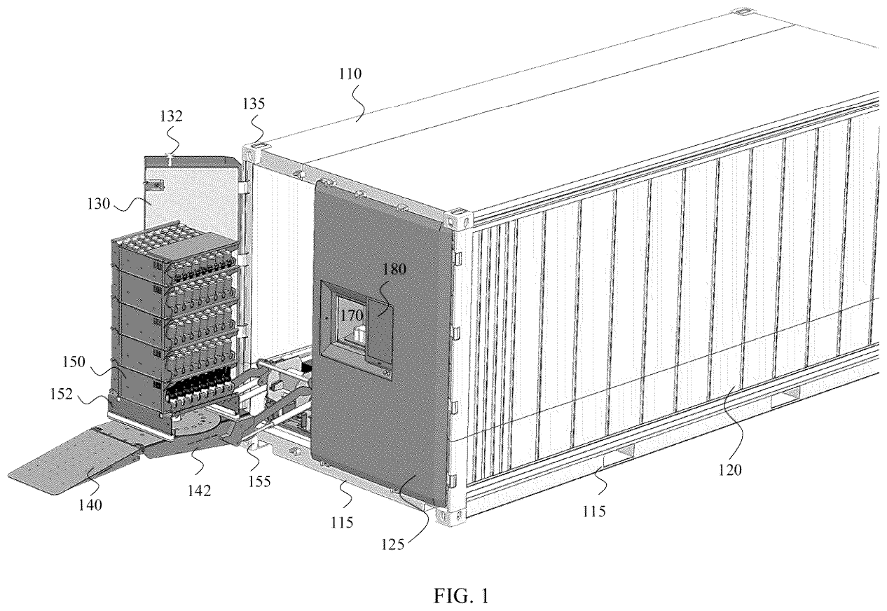

FIG. 1 shows an external view of the delivery station, according to exemplary embodiment of the invention. The external view is defined as a view from outside the delivery station's housing. The housing comprises a base 115, sidewalls 120 extending from the base 115 and a ceiling 110. The shape of the base 115 may be rectangular, for example to be easily carried on a truck/ship. In such case, the housing may have four sidewalls extending from the four edges of the base 115. In some exemplary cases, the size and shape of the housing may be of an intermodal container, easily shipped using trucks, trains and ships, and some mechanical and/or electrical components disclosed herein.

At least one of the sidewalls 120 enables loading goods into the delivery station and delivering goods from the delivery station. When delivering the goods, a kiosk 170 is opened. The kiosk 170 may be formed as a niche in one of the sidewalls 120. In standard mode of operation, the kiosk 170 is closed, for example using a movable sheet. When there is a requirement to open the kiosk, for example to deliver goods from the delivery station, the movable sheet is moved, for example sidewards, upwards, or downwards, enabling a person to access the goods. The goods may be placed on a surface inside the storage volume, such as a shelf located near the top end of the kiosk 170. In some cases, the movable sheet may move in response to a command from a management system of the delivery station. The command may be issued after the person receiving the goods is identified, for example by scanning a code, exchanging signals from the person's cellular phone and the like.

In some exemplary cases, the delivery station further comprises a user interface 180 coupled to one of the sidewalls 120. The user interface 180 enables users to interact with the management system. Such interaction may include identification of persons, request of delivery, initiation of a loading process for loading goods into the housing 110 and the like.

In standard mode or operation, the housing is closed, to facilitate maintenance of desired conditions, such as light, temperature, humidity and the like. When goods are to be loaded into the delivery station, a door 130 of front sidewall 125 of the sidewalls 120 may be opened, to collect the goods 150. In some cases, a door will be open on one of the sidewalls 120 to allow fast replenishing of the delivery station. The goods 150 may be provided on a storage devices such as pallet 152, or on another movable base configured to carry the goods 150.

In standard operation mode, the door 130 is closed, preventing access to the storage volume defined inside the housing and keeping the volume inside the housing 110 in desired conditions, for example in terms of temperature and humidity. In loading mode, the door is either automatically opened, for example by an actuator, or by a mechanism unlocking a lock that prevents the door 130 from moving. The door 130 may move outside from the housing, or inside, towards the storage volume.

When loading new goods into the delivery station, a command is received at the management system to initiate a loading process. The loading process may comprise opening the door 130 and moving a loading ramp 140, 142 outside the storage volume via the aperture created by opening the door 130. The loading ramp 140, 142 may be placed on a surface on which the base is located, such as a floor. The pallet 152 may be placed on the loading ramp 140, 142, or on the ground or floor, and carried onto the loading ramp 140, 142. The loading ramp 140 may have a slope beginning from the ground, shown as an example at the farthest point from the sidewalls 120. This way, the pallet 152 may be carried from the ground onto the loading ramp 140.

The loading ramp 140, 142 is coupled to and maneuvered by loading arms 155 coupled to the delivery station's body, for example to the base or to a structure coupled to the base. The loading arms 155 receive power from an actuator (not shown), such as an engine. During standard operation mode, the loading ramp 140, 142 are located in a loading location inside the storage volume. When loading goods into the storage volume, the loading arms 155 may move the loading ramp 140, 142 from the loading location outside the storage volume. The loading arms 155 may move the loading ramp 140, 142 on any posture or direction desired by a person skilled in the art. Once the pallet 152 is located on the loading ramp 140, 142, the loading arms 155 move the pallet 152 and the loading ramp 140, 142 to the loading location inside the storage volume.

The delivery station may comprise a push-pull module for carrying storage devices such as pallets inside the housing. The push-pull module may also carry the packer when the collector collects the goods. Then, when loading a new storage device, or when removing a storage device from the housing, the push-pull module places the packer in a bay in the housing. Then, when preparing another order, the push-pull module moves to the bay and the packer is placed back on the push-pull module. When loading a new pallet, a push-pull module moves towards the loading location, collects the new pallet 152, and carries the new pallet 152 to a specific area inside the housing. Once the pallet is in place, the delivery station's memory updates that specific goods are located in a specific area. For example, sub-area #5 stores a total of 200 cans, of which 80 cans are diet coke, 50 cans are regular coke, and 70 cans are mineral water. This information may be received from a device operated by a person or robot that provided the pallet 152 outside the delivery station and sent a message that the pallet 152 is ready to be loaded. This information may be provided by a sensor, such as an image sensor, operating in the storage volume, using RFID, image processing techniques and the like.

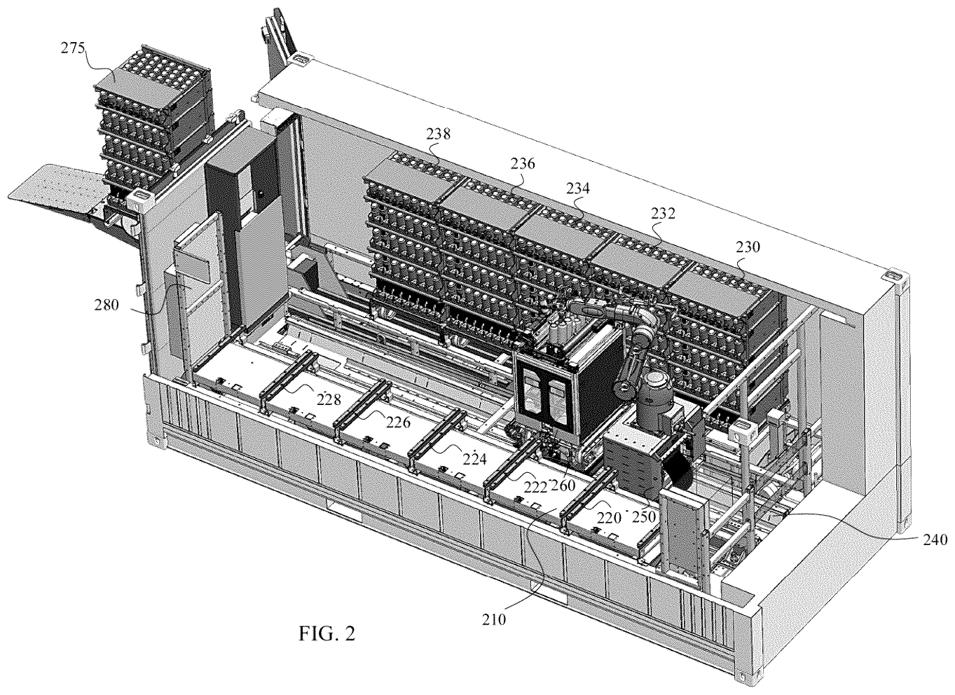

FIG. 2 shows a storage volume of the delivery station, according to exemplary embodiment of the invention.

In some exemplary cases, storage devices are located on both sides of the main track 240. When loaded into the storage volume, the loading arms carry the storage devices 275 to a storage device surface moving along the main track. The storage device surface may be coupled to an actuator receiving commands as to the side track that collects the storage devices 275. For example, the command may be “move the storage device to the third side track to the left”. FIG. 2 also shows storage devices represented as pallets 230, 232, 234, 236, 238 located in the storage positions on the left side of the main track 240 (left when viewed from the door 130), while the storage positions on the right side of the main track 240 are empty.

The delivery station comprises a collector 250 movable along the main track 240. The collector comprises a base coupled to the main track 240 and a collecting arm capable or collecting goods from the storage devices, such as pallets 230, 232, 234, 236, 238. The collector also 250 comprises hardware for executing commands, such as “collect goods from tray #4 in pallet #12”, or a list of goods to be collected and packed as a single order to be delivered. The collector 250 may be coupled to an actuator, such as a motor, that moves the collector 250 along the main track 240. In some other cases, the main track 240 may have magnetic units that attract the collector 250 by applying a magnetic field.

The delivery station comprises a packer 260 for packing goods in a single order to be delivered via the kiosk 280. The packer 260 may move next to the collector 250, such that the collector 250 places goods collected by the collecting arm on a surface or a container of the packer 260. The packer 260 may be coupled to the collector 250 when the collector 250 collects the goods from the storage devices. Such coupling may be defined as the packer 260 being in direct physical contact with the collector 260, or that the packer 260 is placed on a movable element which is coupled to a base on which the collector 250 moves between the storage devices. When all the goods of a certain order are collected and placed on or inside the packer 260, the packer 260 packs the goods, for example by covering the goods in a bag. The bag may be sealed, or partly closed, facilitating carriage by a person. In some cases, the packer 260 may pack goods when the number of collected goods exceeds a threshold, for example due to size or weight constraints, such as pack every 6 cans, even if order is not completed.

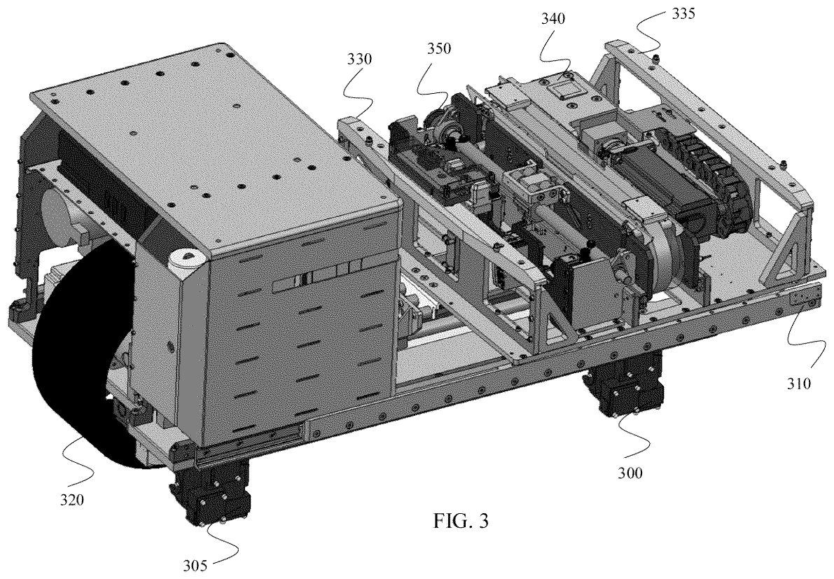

FIG. 3 shows a track bus for carrying the push-pull device, according to exemplary embodiments of the invention. The track bus comprises an interface 300, 305 configured to move along the main track, or along another surface in the delivery station. The interface 300, 305 may be wheels, actuators, bearings and the like. The interface 300, 305 may move in response to change in electrical voltage, in response to commands from a controller located in the track bus, in response to an event sensed by a sensor, and the like.

The track bus comprises an actuator 320 configured to drive the track bus. The actuator 320 may be coupled to a power source such as a battery, electrical grid and the like. The actuator 320 may be an engine. The actuator 320 may be coupled to the interface 300, 305, driving the track bus along the track.

The track bus comprises a base 310 configured to carry the components of the track bus. The base 310 may be made of poles, bars, surfaces and similar components enabling an object to carry other objects. The base 310 may be substantially parallel to the ground. The base 310 may carry the actuator 320 and the push-pull device. The push-pull device comprises sliders 330, 335 on which the pallets are placed when moved along the track.

The push-pull device may carry the pallets when loading and removing the pallets from the delivery station. The push-pull device may also carry the packer device when collecting and preparing deliveries. When the push-pull device carries the packer device, the push-pull device may move laterally relative to the actuator 320, for example in case the collector is placed on the actuator 320, to increase the range of movement of the collector.

The push-pull device comprises a chain module 340 configured to lock on the pallets when moving the pallets into the loading location in which the pallet is placed when the collector collects the goods from the pallet. The push-pull device comprises a lateral driver 350 configured to move the chain module 340 laterally, perpendicular to the axis of the main track.

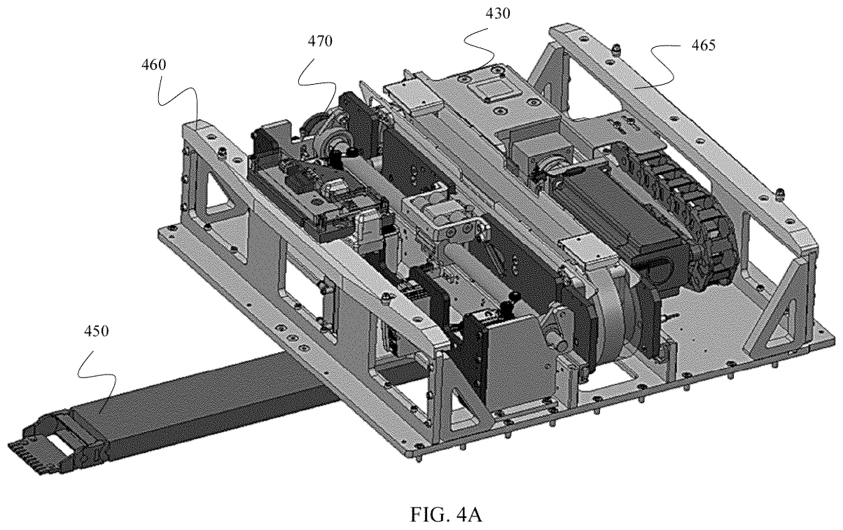

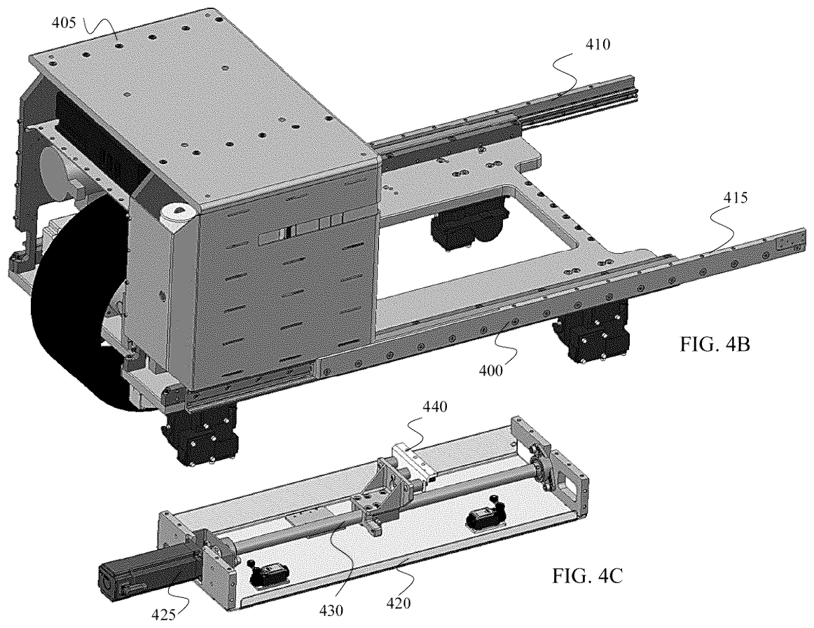

FIGS. 4A-4C show a track bus in a partially exploded view, according to exemplary embodiments of the invention.

FIG. 4B shows the a communication cable 450 of the push-pull device that is configured to transfer commands and messages from the control unit located in the track bus, for example in the platform 405. The push-pull device may comprise lateral driver 470 configured to move the chain module 480 laterally and the chain module 480 configured to lock on the pallets when moving the pallets into the loading location in which the pallet is placed when the collector collects the goods from the pallet. FIG. 4A also shows sliders 460, 465, configured to carry the pallets when the pallets move on top of the push-pull device. FIG. 4B shows the track bus base 400 and arms 410 and 415 extending from the base 400. The push-pull device may move along the arms 410 and 415. A platform 405 is coupled to the base 405. The platform 405 may store the electrical circuitry of the track bus, such as a memory, processor, controller, wireless transceiver, and the like. The platform 405 may be used to carry the collector. The push-pull device may move along the arms 410, and 415 to move away from the platform 405, for example in order to extend the collector's range of movement.

FIG. 4C shows a forward pusher 420 configured to move the push-pull device along the longitudinal axis of the main track. The push-pull device may then slide on arms 410, 415. The forward pusher 420 is coupled to the track bus base 400. The forward pusher 420 may operate in response to a command from the controller of the track bus. The forward pusher 420 is coupled to the push-pull device, for example via pusher connector 440. The pusher connector may move laterally along pusher pole 430. The pusher pole 430 may move rotationally around its axis. The pusher connector 440 may move forward and rearward according to the direction of the rotational movement of the pusher pole 430. For example, the pusher connector 440 may move forward when the pusher pole 430 moves clockwise and may move rearward when the pusher pole 430 moves counter clockwise. The forward pusher 420 may comprise a pusher actuator configured to drive the rotational movement of the pusher pole 430. The forward pusher may alternatively comprise another mechanism or technique for driving the push-pull device along the arms 410, 415.

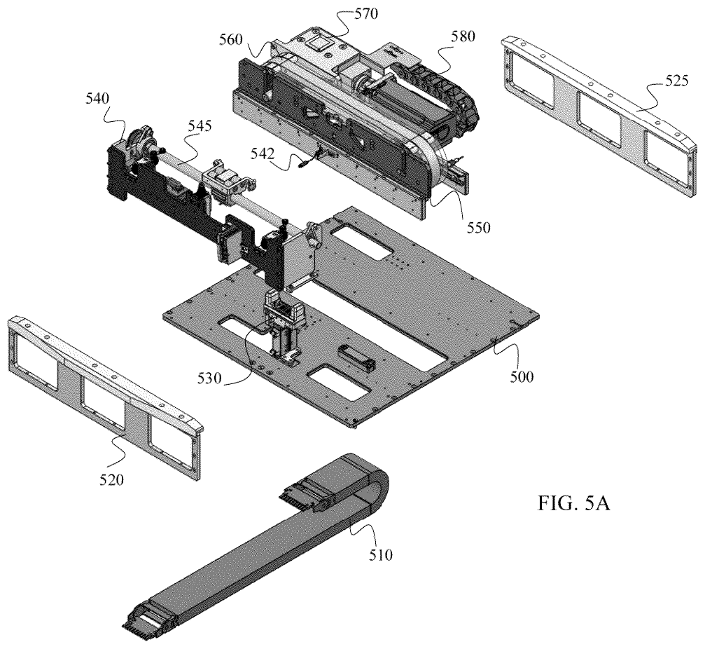

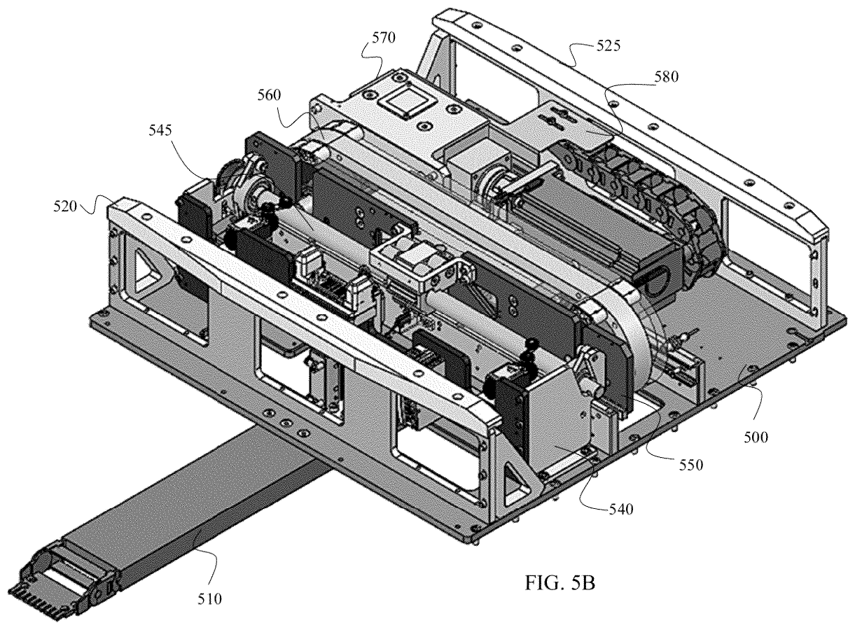

FIGS. 5A-5B show a push-pull device, assembled and in a partially exploded view, according to exemplary embodiments of the invention. The push-pull device comprises a communication cable 510 for transferring data to components located at the push-pull device, such as actuators. In some cases, such data may be transferred over a wireless medium, such as blue-tooth protocol, Wi-Fi, and the like. The push-pull device comprises sliders 520, and 525 on which the pallets are placed. The push-pull device comprises a base 500 configured to carry the components of the push-pull device.

The push-pull device comprises a lateral driver 540. The lateral driver 540 is coupled to the base 500. The lateral driver comprises a driver connector 542 configured to be coupled to the linear guide 550 of the chain module. The driver connector 542 moves along a driver shaft 545 extending perpendicularly to the main axis of the delivery station. This way, an actuator moves the driver shaft 545 in a rotational movement, which in turn moves the driver connector 542 closer to the main track of the delivery station or farther therefrom. As the driver connector 542 is coupled to the linear guide 550, movement of the driver connector 542 results in movement of the linear guide 550 and the chain module towards the pallets or away from the pallet.

The push-pull device also comprises a movable connector 530 coupled to provide at least one of power and data to a component carried by the push-pull device on top of the sliders, for example one of the pallets, a packer device and the like.

The chain module comprises a chain actuator 580 configured to move the chain 560 around wheels. The energy outputted by the chain actuator 580 may be converted into linear movement of the chain 560 using transmission mechanism 570.

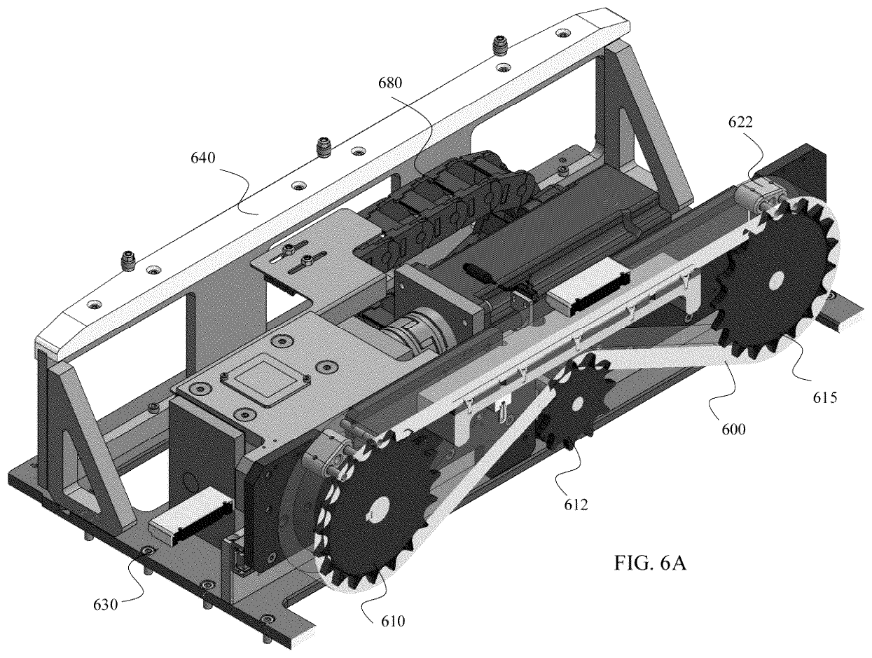

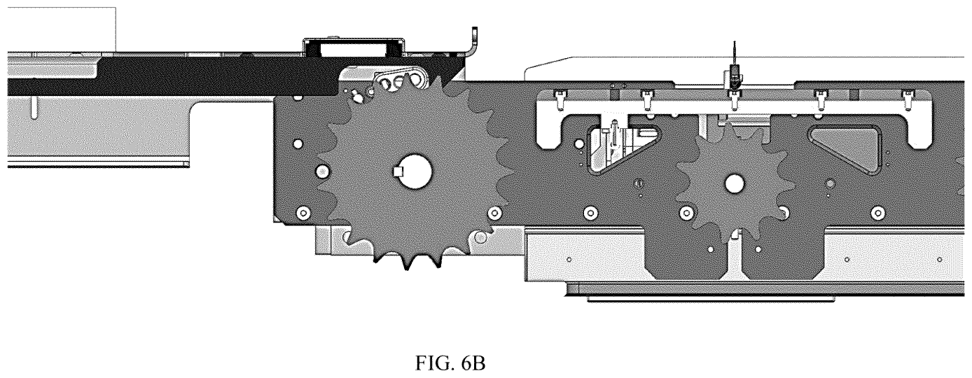

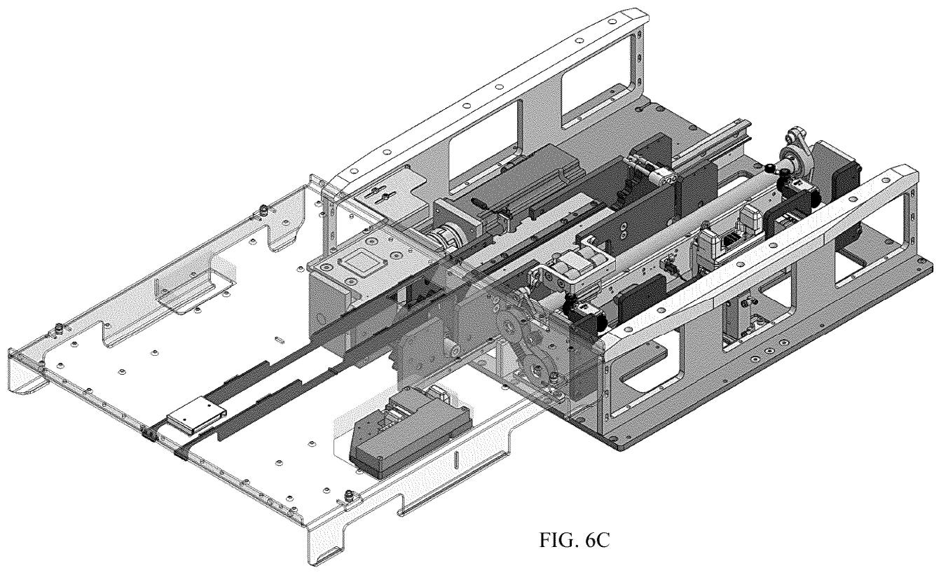

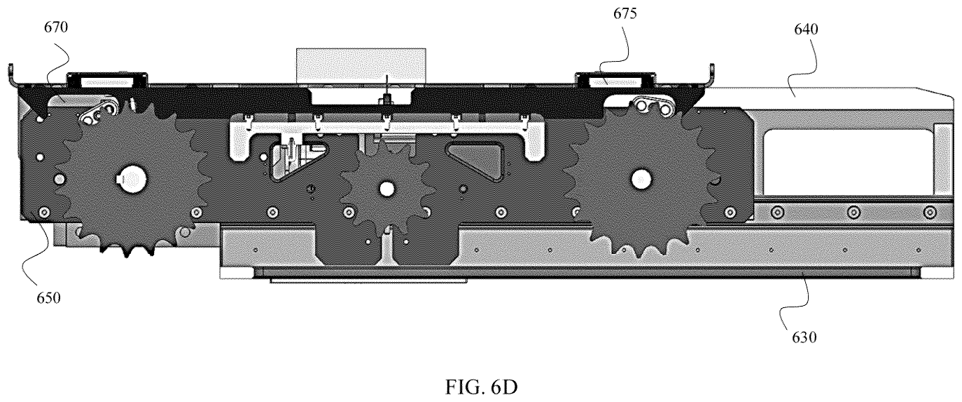

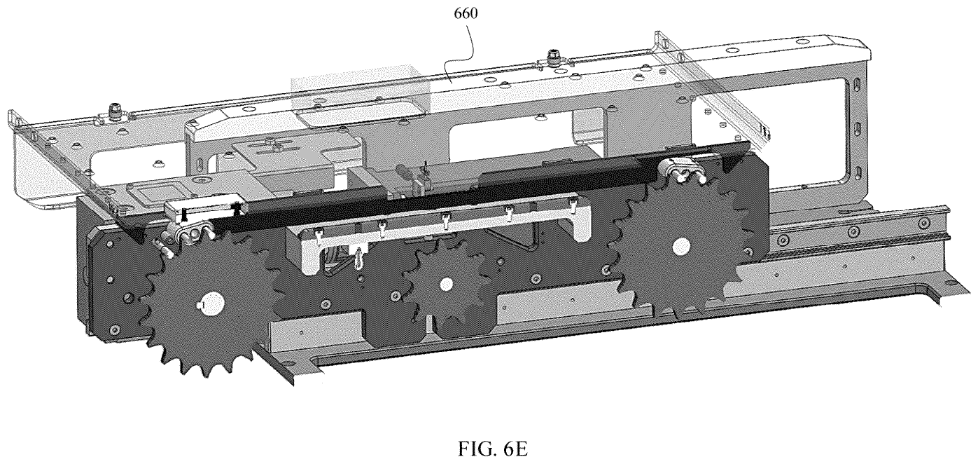

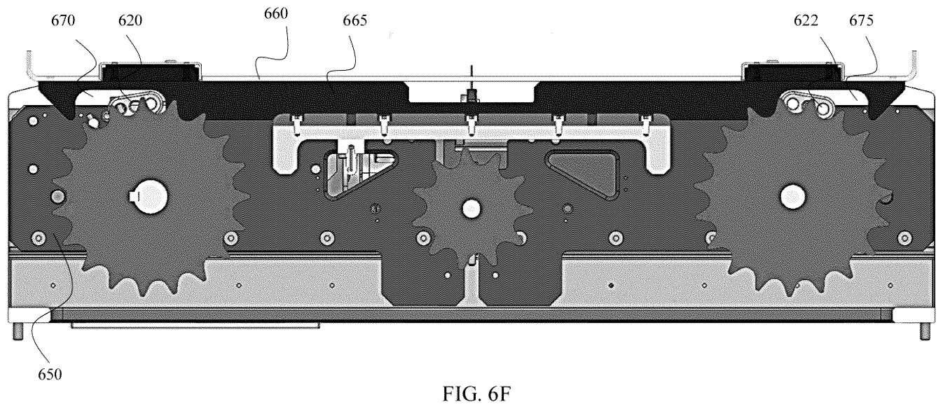

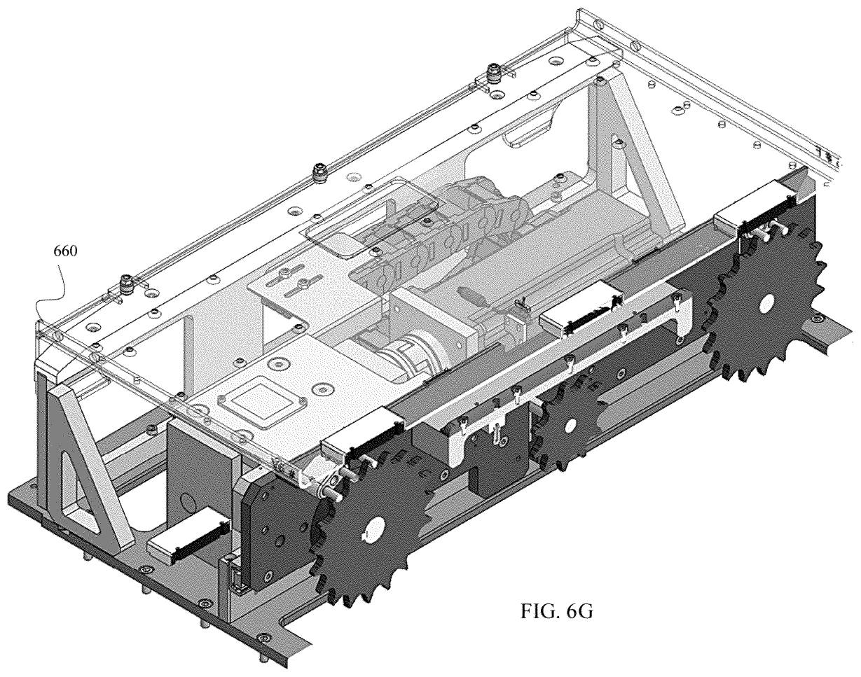

FIGS. 6A-6G show the push-pull device in various positions when loading and unloading a pallet, according to exemplary embodiments of the invention.

FIG. 6A shows the chain module in an initial position, in which the chain 600 is placed entirely on the base 630. The chain 600 is tensed around front wheel 610, rear wheel 615 and tensing wheel 612. The chain 600 comprises one or more locking units 620, 622, configured to be locked inside niches in a bottom part of the pallets. The bottom part may be a bottom surface of the pallet.

FIG. 6B shows the push-pull device in an engaging position. In the engaging position, the locking units slide inside a niche of the chain. Once the locking unit is inside the niche of the chain, and the chain continues to rotate around the wheels, the niche moves along with the locking unit of the chain, and the surface to which the locking unit is locked moves accordingly, towards the base 630 of the push-pull unit.

FIG. 6C is an isometric view of the push-pull device in an engaging position.

FIG. 6D shows a side view of the chain module, in which the locking units 620, 622, are located inside niches 670, 672, respectively. The chain 600 moves around the wheels 610, 615, until one of the locking units 620, 622 arrives at one of the niches 670, 672. When a locking unit slides into a niche, the chain 600 can move the surface 660 that carries the pallet.

FIG. 6E shows the chain module 600 moving away from the base 630. The lateral movement of the chain module is initiated by lateral movement of the linear guide 650. The linear guide is coupled to the connector of the driver connector 542 of the lateral driver. The lateral driver moves the chain away from the main track of the delivery station, until the chain 600 reaches a niche 670, 672 in a bottom part of a surface that carries the pallet. FIG. 6C shows an offset between a lateral location of the linear guide 650 relative to the slider 640 that does not move in tandem with the lateral driver.

FIG. 6F shows the chain 600 being located under the surface 660 that carries the pallet. The surface 660 moves towards the sliders as a result of movement of the chain 600 after the locking units 620, 622 entered the niches 670, 672 in the bottom part of the surface 660. The side view of the push-pull module also shows a sensor configured to detect the location of the surface 660 relative to the push-pull device. When the surface 660 is in a predefined location, the sensor sends a signal to a control unit that moves a pallet connector configured to connect the push-pull device with the pallet or with another object carried by the push-pull device, for example a packer device.

FIG. 6G is an isometric view of the pallet being placed on top of the push-pull device.

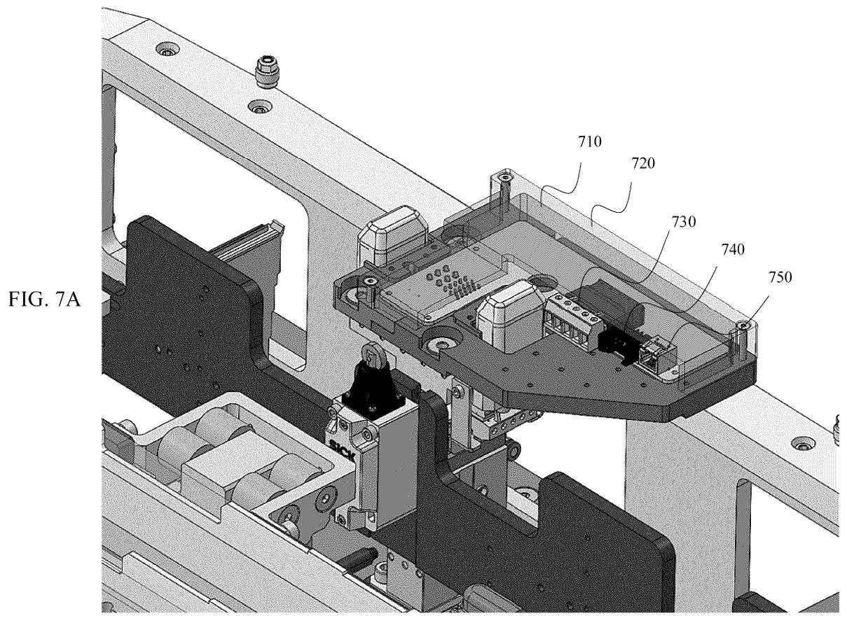

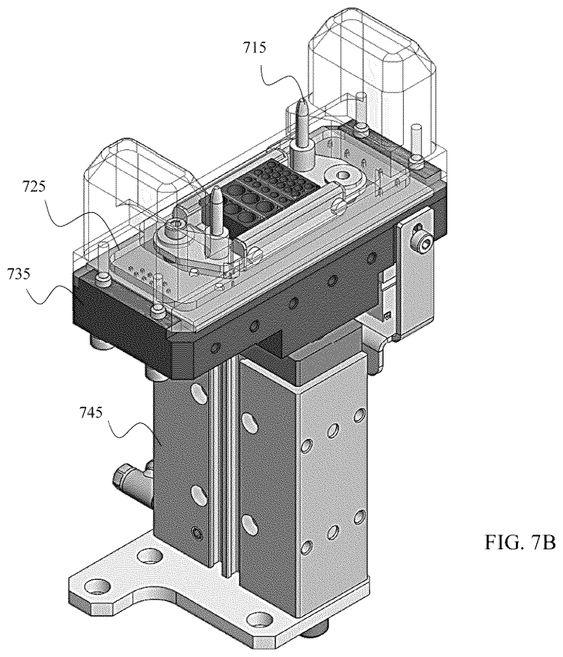

FIGS. 7A-7B show a movable connector of the push-pull device, according to exemplary embodiments of the invention. The movable connector is coupled to the base of the push-pull device, such as base 500 shown above. The movable connector comprises a body 710 connected to a piston. The piston moves the body 710 upwards when there is a requirement to be coupled to the pallet or packer device, and moves the body 710 downwards when detaching from the pallet or packer.

The body 710 forms a mechanical structure for electronic components configured to provide power and/or data to the pallet or packer device. Upper connector 720 is configured to form a physical interface between the base 710 and a connector of the pallet or packer. The electrical components comprise at least one of high power connector 730 configured to provide high power to the pallet/packer, 24V connector 740 and data connector 750 configured to send and/or receive data with the electrical circuitry of the pallet/packer.

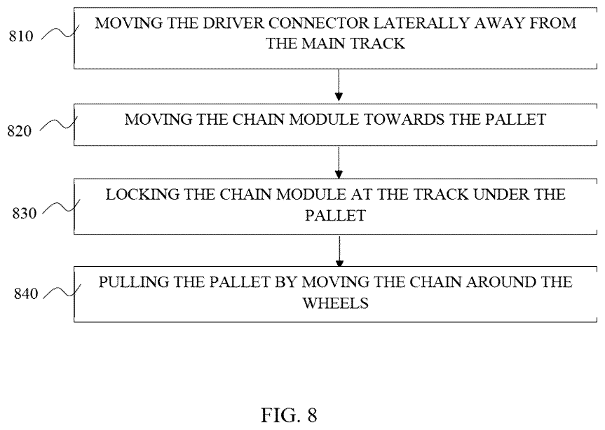

FIG. 8 shows a method for moving a pallet from a volume, according to exemplary embodiments of the invention.

Step 810 discloses moving the driver connector laterally away from the main track.

Step 820 discloses moving the chain module towards the pallet.

Step 830 discloses locking the chain module at the track under the pallet.

Step 840 discloses pulling the pallet by moving the chain around the wheels

The autonomous system comprises a memory for storing information. The memory may store a set of instructions for performing the methods disclosed herein. The memory may also store rules for operating the autonomous system, for example algorithms for collecting goods from the storage devices when receiving a new order, commands to be sent to the robotic arm, and the like. The autonomous system may also comprise a communication unit for exchanging information with other systems/devices, such as user's devices, remote warehouses when requesting new goods to be loaded, and the like. The autonomous system comprises a processor for executing the instructions stored in the memory. The processor may be a general purpose processor, a microprocessor, or any other processor desired by a person skilled in the art.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed invention not be limited to the particular embodiments described herein.

What is claimed is:

1. A delivery station for delivering goods, comprising:
a main track;
one or more storage devices located along the main track, the one or more storage devices store the goods delivered by the delivery station; and
a push-pull device configured to move along the main track, said push-pull device is configured to carry one of the one or more storage devices along the main track, said push pull device comprises:
an actuator for moving the push-pull device, and
a mechanism configured to lock on one of the one or more storage devices and to move the one of the one or more storage devices in a direction perpendicular to a longitudinal axis of the main track.

2. The delivery station of claim 1, wherein the mechanism comprises a chain movable around the push-pull device, wherein movement of the chain moves the one of the one or more storage devices towards the main track or away from the main track.

3. The delivery station of claim 2, wherein the chain comprises multiple interconnected chain members, at least one of the interconnected chain members is a locking unit configured to be locked inside niches on a bottom part of one of the one or more storage devices.

4. The delivery station of claim 2, wherein the push-pull device further comprises a lateral driver coupled to the chain, wherein the lateral driver moves the chain in a direction perpendicular to a longitudinal axis of the main track.

5. The delivery station of claim 4, wherein the lateral driver comprises a driver connector, said driver connector is coupled on a distal part to a linear guide of the chain and on a proximal part to a moving axis, wherein movement of the moving axis results in linear movement of the chain in a direction perpendicular to a longitudinal axis of the main track.

6. The delivery station of claim 2, wherein the push-pull device further comprises a chain actuator configured to move the chain.

7. The delivery station of claim 1, further comprising a track bus configured for carrying the push-pull device, wherein the track bus comprises an interface configured to move along the main track.

8. The delivery station of claim 7, wherein the track bus further comprises a forward pusher configured to move the push-pull device along a longitudinal axis of the main track.

9. The delivery station of claim 7, wherein the track bus further comprises a movable connector configured to supply electrical power to the one of the one or more storage devices when carried by the push-pull device, wherein the movable connector moves upwards when the one of the one or more storage devices is located in a predefined location on top of the push-pull device.

10. The delivery station of claim 7, wherein the track bus further comprises a sensor for sensing the predefined location of the one of the one or more storage devices on top of the push-pull device.
